(19) United States
(12) Patent Application Publication
(10) Pub. No.: US 2010/0245268 A1
(43) Pub. Date: Sep. 30, 2010

(54) USER-FRIENDLY PROCESS FOR INTERACTING WITH INFORMATIONAL CONTENT ON TOUCHSCREEN DEVICES

(75) Inventors: Alexis Tamas, Paris (FR); Amaury Grimbert, Paris (FR)

Correspondence Address: HARNESS, DICKEY & PIERCE, P.L.C., P.O. BOX 828, BLOOMFIELD HILLS, MI, 48303, US

(73) Assignee: STG Interactive S.A., Paris (FR)

(21) Appl. No.: 12/615,501

(22) Filed: Nov. 10, 2009

Related U.S. Application Data
(60) Provisional application No. 61/164,606, filed on Mar. 30, 2009.

(51) Int. Cl. G06F 3/041

(52) U.S. Cl. 345/173

(57) ABSTRACT

An electronic device includes: a touchscreen linked to an electrical circuit controlling a display, an informational display zone being reserved for the display of informational content, a command display zone being reserved to the display of at least one graphic representation of a command pad, and a tactile action on one of the command pads provoking the selection of one of the associated data processing functions.

### CROSS-REFERENCE TO RELATED APPLICATIONS

This application claims the benefit of U.S. Provisional Application No. 61/164,606, filed on Mar. 30, 2009 which is incorporated by reference herein.

BACKGROUND AND SUMMARY

It is known in the state of the art an existing solution implementing a simple screen or touchscreen, as well as one or more electromechanical elements such as a hardware button, scroll wheel or trackball. The use of such an electromechanical element implicates a significant cost relating not only to the cost of the component, but also to the complexity of the assembly and maintenance processes. Moreover, since these elements are heavily used by the user, they may break down, making the equipment concerned virtually impossible to use.

It is known in the state of the art another solution implementing a multi-touch screen allowing the selection of an interactive function through a tactile action on the display surface. This solution is not fully satisfactory. Firstly, the user hides a portion of the displayed information when he puts his finger on the tactile surface, which can lead to selection errors. Secondly, this solution often requires arbitration between the size reduction of the displayed objects, in order to enrich the content presented to the user, and an increase of the size of these same objects, for a selection to be made with reasonable dexterity. This arbitration often being difficult, the user has no other solution than repeatedly modify the enlargement of the displayed objects by using the “zoom” functions. This way of proceeding is not very ergonomic and results in an increased consumption of electricity, each change in size requiring resampling processes of the content by the CPU, as well as recalculations of the processes for the multi-touch detections.

The purpose of the current invention is to solve these problems by proposing an inexpensive equipment, together with a reduced electrical consumption and a greater reliability, as well as with improved ergonomics as compared to the existing solutions (prior art). The user may use all the functions with a single hand, contrary to multi-touch solutions which require the actions of multiple fingers of the same hand, the other hand holding the equipment. In addition, the invention makes it possible to offer all the functional richness of the solutions of prior art when using touchscreens that do not detect several simultaneous contact points.

Definitions: In the following invention:

“Touchscreen” is a display that can detect the presence and location of a touch within the display surface or on a part of the display surface. The term generally refers to a touch or contact to the display of the device by a finger or hand. Touchscreens can also sense other passive objects, such as a stylus.

“Informational content” refers to graphical or textual information presented by applications running on the device. Part of the content may be issued from remote servers (e.g. web pages presented in a web browser application).

An informational content includes one or more functional objects corresponding to specific user actions. Functional objects may be of any size, including small sizes, depending on the design of the informational content. In this context, on an electronic device with a touchscreen, when using a finger, the touch area (finger contact area) on the touchscreen may be much larger than the functional objects in the information content. In such a case, interacting with content may not be possible for users without generating errors (e.g. touching an adjacent functional object).

Moreover, in prior art, touching the display with a finger hides a portion of the content beneath, which diminishes the user's accessibility to the informational content. This problem can be aggravated when the device display pitch is small because functional objects can be displayed particularly small in this case.

Software solutions exist in which users may zoom in to the informational content to magnify the functional objects so that they become larger than the touch area. These solutions are not user-friendly because users have to zoom in and out very frequently (zooming out is necessary for viewing the entire visible content). Moreover, zooming in and out will result in an increased power consumption if the effect is implemented using multi-touch detection (e.g. the iPhone™)

### BRIEF DESCRIPTION OF THE DRAWINGS

FIGS. 1-8 are views of an embodiment of the electronic device.

### DETAILED DESCRIPTION

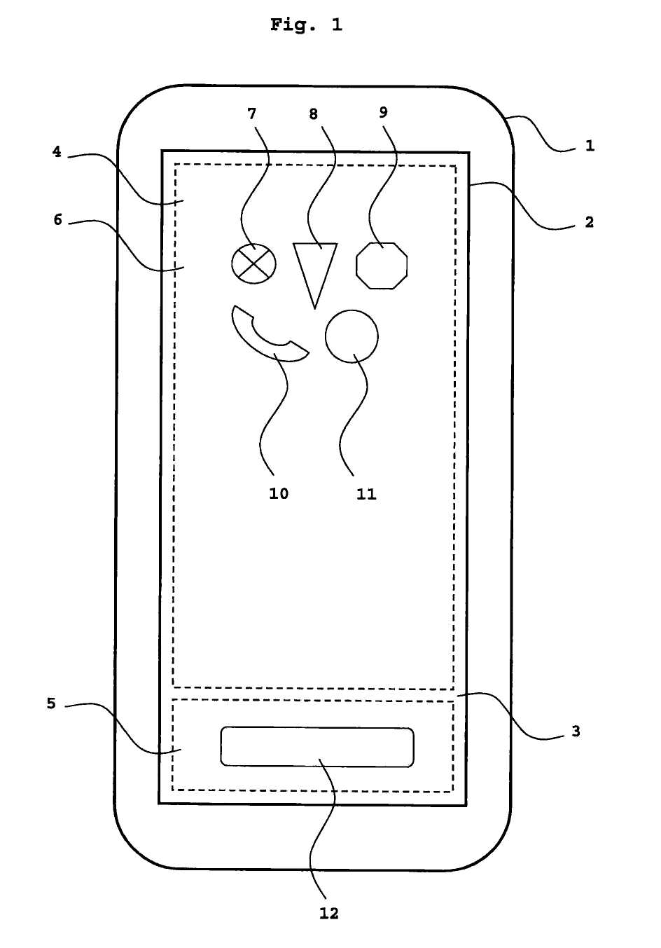

FIG. 1 describes an embodiment of the invention. The electronic device (1) comprises a touchscreen (2). The display surface (3) of the touchscreen (2) provides two display zones:
the larger display zone is the informational display zone (4), dedicated to the display of the graphical and textual informational content (6), some of them being functional objects (7 to 11)
the smaller display zone is the command display zone (5), dedicated to the display of tactile command icons and a command pad (12) in order to command the modification of the informational content (6) displayed in the informational display zone (4).

The functional objects (7 to 11) are displayed in the informational content (6). Each of the functional objects (7 to 11) is associated with a corresponding processing function. These functions are not tactually activated by a touch at the display location corresponding to functional objects displayed in the informational content (6). The functional objects (7 to 11) may be of any size, including small sizes, depending on the design of the informational content (6).

The activation of the corresponding processing function requires a first step of selecting one of the functional objects (7 to 11) by a tactile action in the command pad (12), and further, activating the selected functional object (7 to 11) by an additional tactile action. A drawback in the solution is the necessity to reserve a zone of the display surface (3) for the command display zone (5). The reserved command display zone (5) cannot be used for presenting the informational content (6). However, the reserved command display zone (5) could be typically limited to less than 20% of the display surface (3).

To enhance the user's experience, each selection of a functional object (7 to 11) can be accompanied by a sound, a vibration or an other haptic effect on the device. To enhance the user's experience, the sensitivity of the command pad (12) can vary, depending on the velocity and/or the amplitude of the tactile action. It can also depend on changes in the direction of the tactile action. For example, if the tactile action corresponds to the sliding of the finger on the command pad (12), passing from one selection to another may require a minimum sliding distance in either direction.

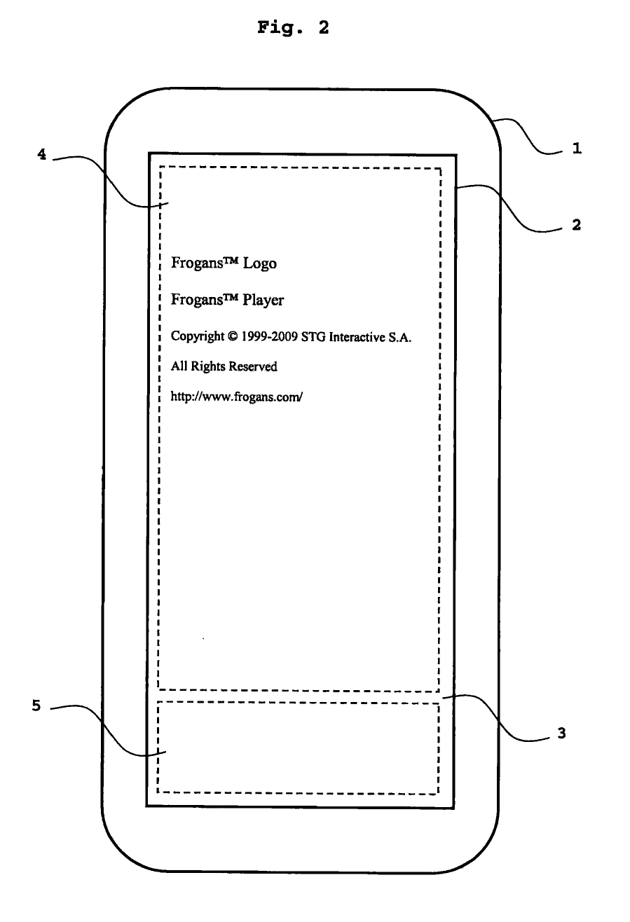

FIGS. 2 to 8 illustrate this implementation for touchscreen mobile devices running operating systems such as Windows CE™, Android™, Symbian™ OS and iPhone™ OS. In this implementation, the informational content (6) is called a Frogans™ site.

Start Screen

FIG. 2 shows an example of a start screen. During the loading of the program in the active memory, both the informational display zone (4) and the command display zone (5) are inactive. The informational display zone (4) shows information about the program, i.e. “Frogans™ Player” program provided by STG Interactive S.A.

Mosaic View Displaying Four Frogans™ Sites Opened on the Device

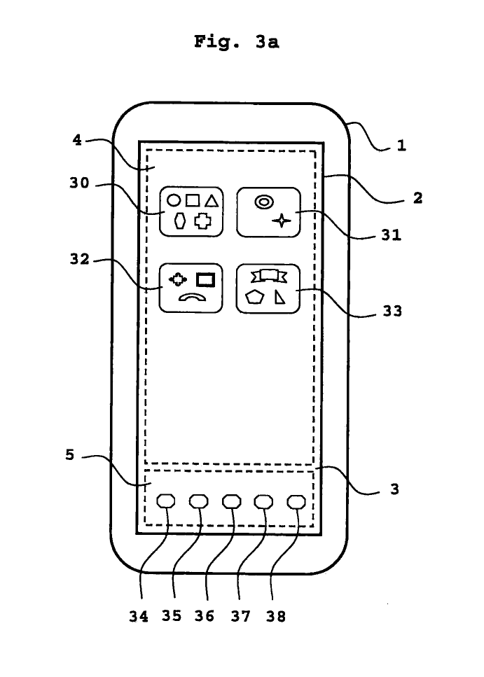

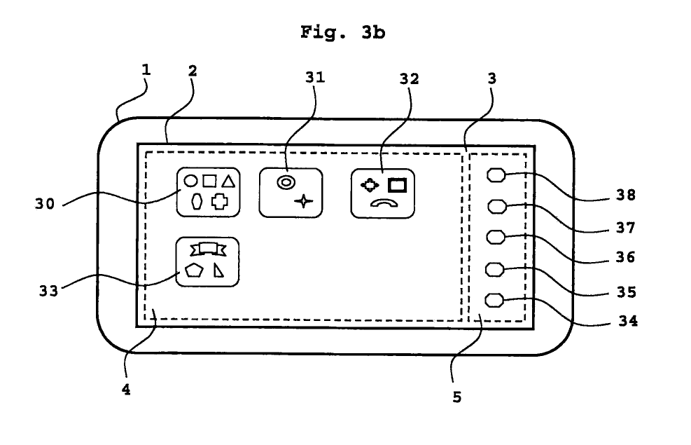

FIGS. 3a and 3b show an example of a mosaic view displaying, in small size, four informational content (30, 31, 32, 33) opened on the device. Each informational content is associated with a Frogans™ site in this example. But it could also be associated with a widget or a website.

The display surface (3) can be oriented in “Portrait mode” (FIG. 3a) or in “Landscape mode” (FIG. 3b). If the number of Frogans™ sites opened on the device exceeds the display capacity of the informational display zone (4), additional mosaic views are created. The user can slide his finger over the mosaic view parallel to the command display zone (5) (horizontally in portrait mode and vertically in landscape mode) to scroll between the different views of the mosaic.

A single touch (tap) on a Frogans™ site in the mosaic view gives access to the interactive view for navigating that Frogans™ site. The command display zone (5) contains (from left to right in portrait mode and from bottom to top in landscape mode) five buttons for accessing:
the menu of Frogans™ Player (34)
the Frogans™ address input interface (35)
the Frogans™ favorites list (36)
the recently visited list (37)
the theme selector (38). The user makes a single touch (tap) in the informational content (30) displayed in the mosaic view, corresponding to a specific Frogans™ site, to start navigating that Frogans™ site.

Interactive View for Navigating a Frogans™ Site Using the Solution: Step 1 of 5

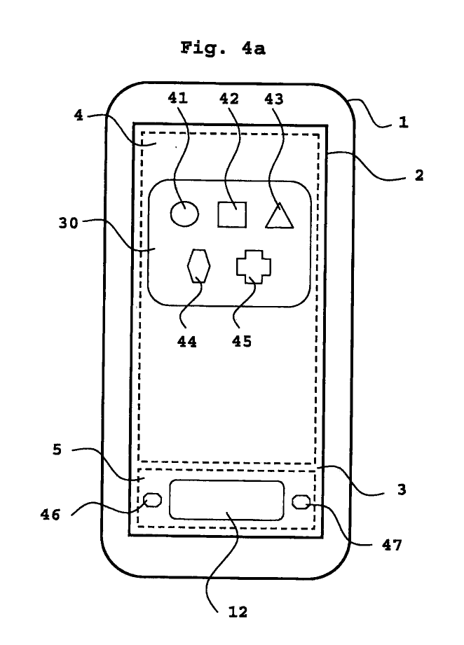

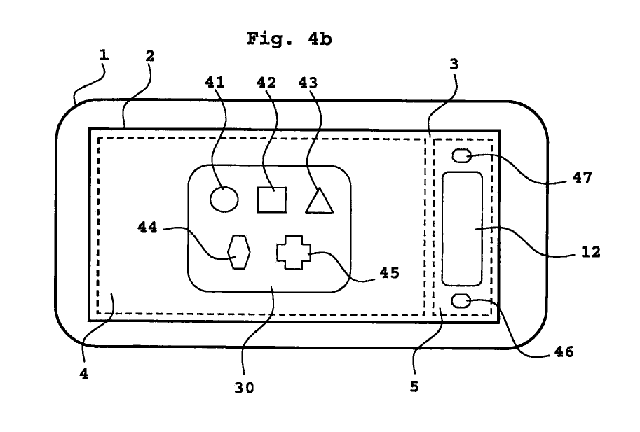

FIGS. 4a and 4b show an example of step 1 of 5 of an interactive view for navigating a Frogans™ site using the solution. The display surface (3) can be oriented in “Portrait mode” (FIG. 4a) or in “Landscape mode” (FIG. 4b). A single touch (tap) on the Frogans™ site gives access to the mosaic view.

Five functional objects (41 to 45) are displayed in the informational content (30). The user can slide his finger over the Frogans™ site parallel to the command display zone (5) to scroll between the different Frogans™ sites opened on the device. If the user slides his finger over the Frogans™ site perpendicular to the command display zone (5), the Frogans™ site is resized on screen (becoming smaller if the movement is toward the command display zone (5), larger otherwise).

The command display zone (5) contains two buttons for accessing:
the menu of Frogans™ Player (46)
the menu of the Frogans™ site (47) It also contains the command pad (12), positioned between the two buttons (46, 47). In step 1, the user has not yet slid his finger on the command pad (12).

Interactive View for Navigating a Frogans™ Site Using the Solution: Step 2 of 5

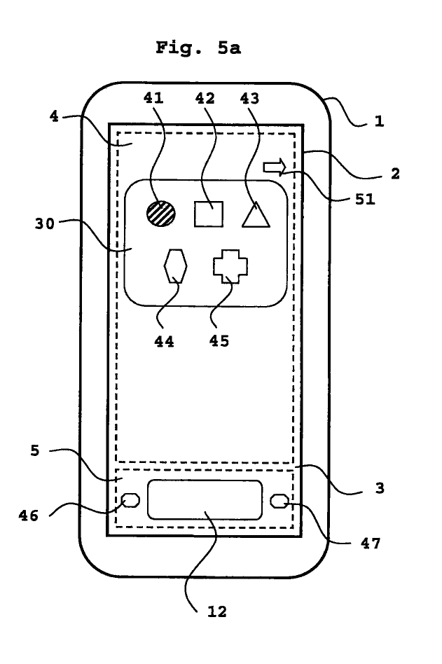

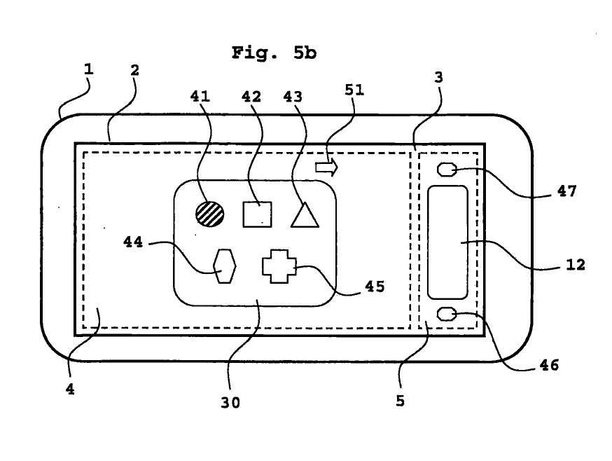

FIGS. 5a and 5b show an example of step 2 of 5 of an interactive view for navigating a Frogans™ site using the solution. The display surface (3) can be oriented in “Portrait mode” (FIG. 5a) or in “Landscape mode” (FIG. 5b).

In step 2, the user has started to slide his finger on the command pad (12) (from left to right in portrait mode and from top to bottom in landscape mode). A functional object (41) among the five displayed functional objects (41 to 45) is now selected by a slide of the finger on the command pad (12). A destination flag (51) is displayed above the Frogans™ site in the informational display zone (4), indicating that the selected functional object (41) corresponds to the navigation to another page in the Frogans™ site.

To help the user in navigating, six different destination flags can be displayed, corresponding to:
another page in the Frogans™ site
an input form in the Frogans™ site
a link to another Frogans™ site
a link to a web page
a link to a secured web page (SSL)
a link to an email address.

Interactive View for Navigating a Frogans™ Site Using the Solution: Step 3 of 5

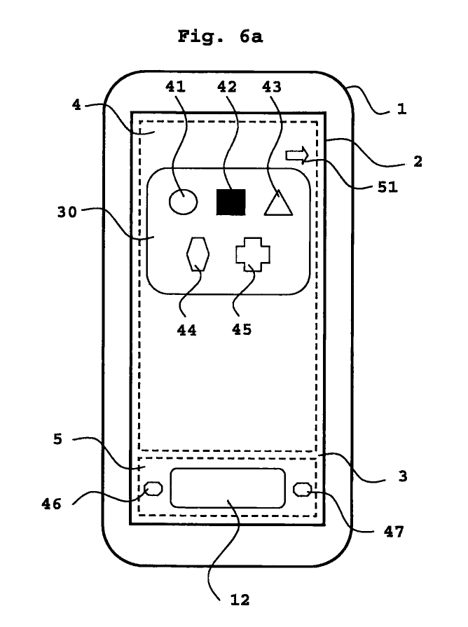

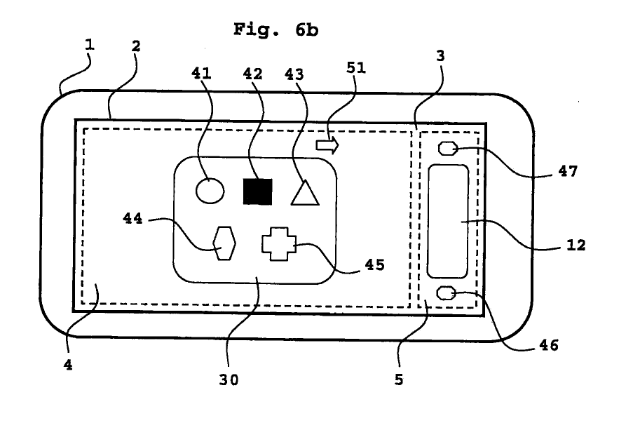

FIGS. 6a and 6b show an example of step 3 of 5 of an interactive view for navigating a Frogans™ site using the solution. The display surface (3) can be oriented in “Portrait mode” (FIG. 6a) or in “Landscape mode” (FIG. 6b).

In step 3, the user has continued to slide his finger on the command pad (12) (from left to right in portrait mode and from top to bottom in landscape mode). Another functional object (42) among the five displayed functional objects (41 to 45) is now selected by a slide of the finger on the command pad (12). A destination flag (51) is displayed above the Frogans™ site in the informational display zone (4), indicating that the selected functional object (42) corresponds to a navigation link to another page in the Frogans™ site. By sliding the finger in the opposite direction on the command pad (12) (from right to left in portrait mode and from bottom to top in landscape mode), the previously selected functional object (41) can be selected again.

Interactive View for Navigating a Frogans™ Site Using the Solution: Step 4 of 5

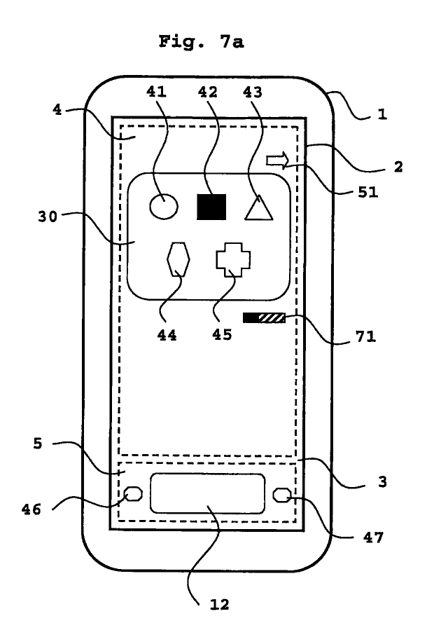

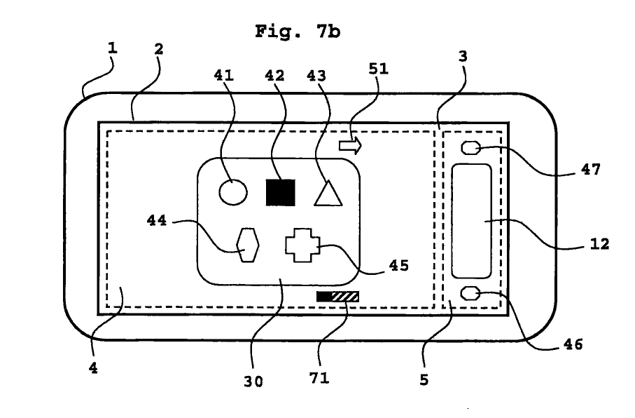

FIGS. 7a and 7b show an example of step 4 of 5 of an interactive view for navigating a Frogans™ site using the solution. The display surface (3) can be oriented in “Portrait mode” (FIG. 7a) or in “Landscape mode” (FIG. 7b).

In step 4, the user has stopped sliding his finger and has made a single touch (tap) on the command pad (12). Navigation to another page in the Frogans™ site has started. A progress bar (71) is displayed below the Frogans™ site in the informational display zone (4). During the loading of the new page, the user can still select another functional object corresponding to another action. He may also scroll to other Frogans™ sites opened on the device and may access the mosaic view.

Interactive View for Navigating a Frogans™ Site Using the Solution: Step 5 of 5

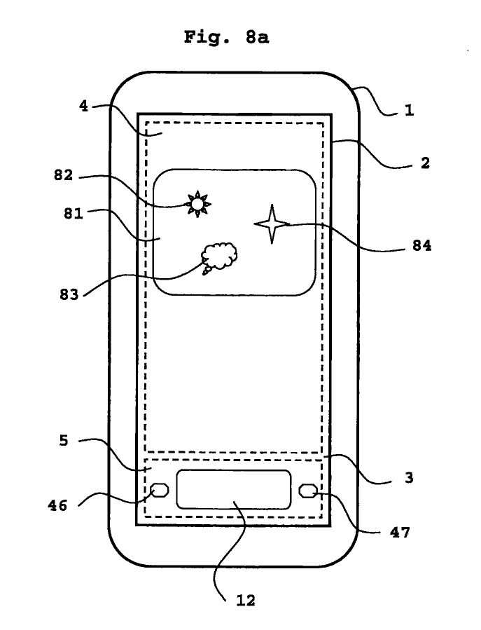

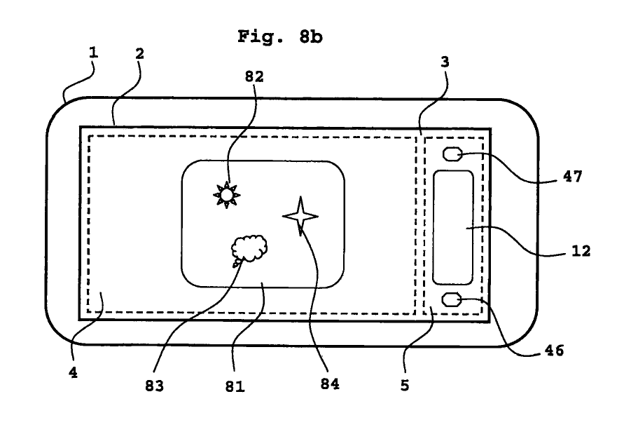

FIGS. 8a and 8b show an example of step 5 of 5 of an interactive view for navigating a Frogans™ site using the solution. The display surface (3) can be oriented in “Portrait mode” (FIG. 8a) or in “Landscape mode” (FIG. 8b).

In step 5, the new page of the Frogans™ site, corresponding to a new informational content (81), is now loaded and displayed. Three functional objects (82 to 84) are displayed in the informational content (81). The user can continue to navigate the Frogans™ site, as he did in the previous steps.

The invention claimed is:

1. An electronic device comprising:
a touchscreen linked to an electrical circuit controlling a display as well as the detection of at least one contact on the surface of the display surface, the electrical circuit commands, at least two distinct display zones;
an informational display zone being reserved for the display of informational content comprising functional objects, each of the functional objects being associated to a data processing function;
a command display zone being reserved to the display of at least one graphic representation of a command pad; and
a tactile action on one of the command pads provoking the selection of one of the associated data processing functions, producing a graphic modification of one of the functional objects of the informational display zone corresponding to the selected function;
the execution of the associated function being fulfilled by another tactile action.

2. The electronic device according to claim 1, wherein the informational display zone comprises no tactile command susceptible to select one of the said associated data processing functions.

3. The electronic device according to claim 1, wherein the touchscreen is a screen detecting a single instantaneous tactile contact.

4. The electronic device according to claim 1, wherein the command pad provides a signal of position indexed on a path, each position corresponding to the selection of one of the data processing functions.

5. The electronic device according to claim 1, wherein the interpretation of the tactile position at a time Tᵢ on the path takes into account the previous position Tᵢ₋₁, in order to create a hysteresis.

6. The electronic device according to claim 1, further comprising an orientation sensor of the screen controlling the relative position of the informational display zone and of the command display zone.

7. The electronic device according to claim 1, further comprising a plurality of command display zones.

8. The electronic device according to claim 1, wherein at least one part of the screen includes a haptic effect.

9. The electronic device according to claim 1, further comprising sound capabilities activated during the selection of one of the functional objects.

10. The electronic device according to claim 1, wherein the order of the selection of functional objects is made with respect to one of the dimensions of the display surface, this order corresponding to the indexation order of the command pad according to the same dimension of the display surface.

11. The electronic device according to claim 1, wherein the command display zone is displayed conditionally, according to a specific action of activation, the activation of the display of the command display zone provoking the resizing of the informational display zone.

12. The electronic device according to claim 1, wherein the interpretation of the tactile position depends on the orientation of the equipment.
